(19) United States
(12) Patent Application Publication
(10) Pub. No.: US 2014/0168200 A1
(43) Pub. Date: Jun. 19, 2014

(54) PROJECTOR WITH MAIN IMAGE MODULE AND SECONDARY IMAGE MODULE

(71) Applicant: HON HAI PRECISION INDUSTRY CO., LTD., New Taipei (TW)

(72) Inventor: CHIH-CHEN LAI, New Taipei (TW)

(73) Assignee: HON HAI PRECISION INDUSTRY CO., LTD., New Taipei (TW)

(21) Appl. No.: 13/865,216

(22) Filed: Apr. 18, 2013

(30) Foreign Application Priority Data
Dec. 17, 2012 (TW) 101147750

(51) Int. Cl. G03B 21/14

(52) U.S. Cl. CPC G03B 21/142
USPC 345/214

(57) ABSTRACT

A projector includes a main image module and a secondary module. The main image module includes a main projecting unit and a main control unit outputting a main image signal to the main projecting unit. The main projecting unit projects a main image according to the main image signal. The secondary image module includes two secondary projecting units and a secondary control unit outputting a background image signal to the secondary projecting units. The secondary projecting units project two background images according to the background image signal. The two secondary projecting units are positioned at two sides of the main projecting unit, and the background images coordinate with the background of the main image.

### BACKGROUND

1. Technical Field

The present disclosure relates to projectors and, particularly, to a projector capable of projecting a background image surrounding a main image.

2. Description of Related Art

Projectors generally include a lens module for projecting images on a screen. When a background color of the images projected from the projector is greatly different with that of the screen, the images appear inharmonious.

Therefore, it is desirable to provide a projector, which can overcome the limitations described.

### BRIEF DESCRIPTION OF THE DRAWINGS

FIG. 1 is a front view of a projector in accordance with an exemplary embodiment.

FIG. 2 is a functional block diagram of the projector of FIG. 1.

FIG. 3 is a schematic view illustrating the projector of FIG. 1 projecting a background image surrounding a main image.

### DETAILED DESCRIPTION

Embodiments of the disclosure will be described with reference to the drawings.

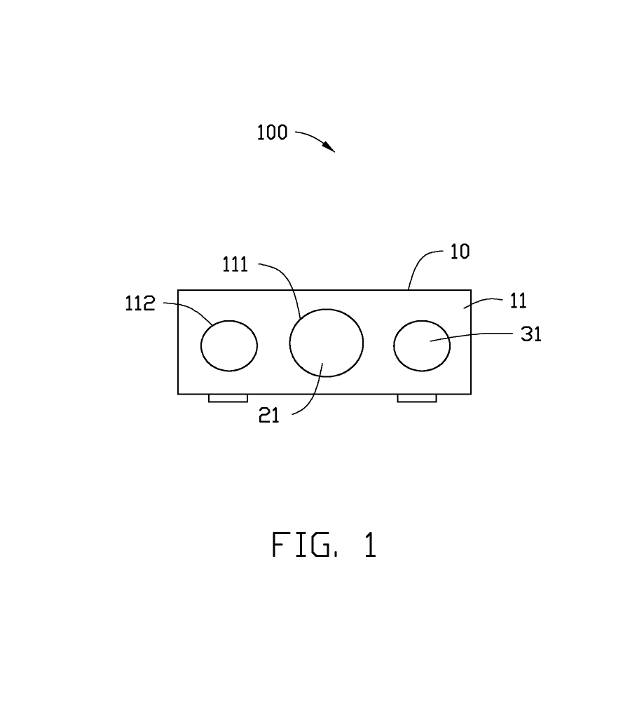

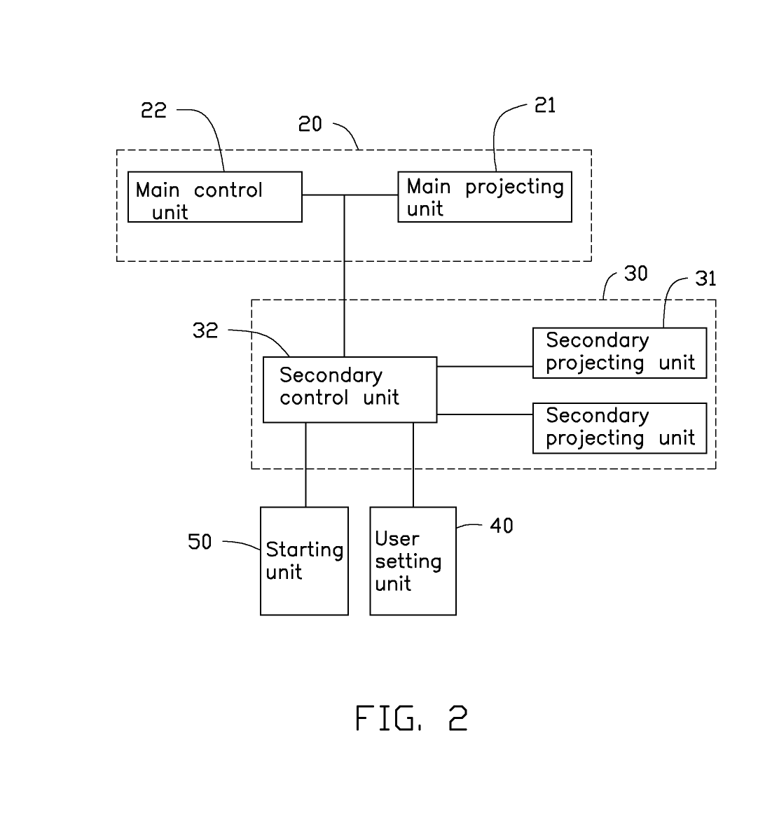

FIGS. 1-2 show a projector 100 according to an exemplary embodiment. The projector 100 includes a main body 10, a main image module 20, a secondary image module 30, a user setting unit 40, and a starting unit 50. The projector 100 can be a digital light processor (DLP) projector, a liquid crystal display (LCD) projector, or a liquid crystal on silicon (LCoS) projector. In this embodiment, the projector 100 is the DLP projector.

The main body 10 is a cuboid and is assembled with a light source, a circuit board, and a dissipation device. The main body 11 includes a front side 11 facing a screen. The main body 11 defines a main lens hole 111 and two secondary lens holes 112 in the front side 11. The two secondary lens holes 112 are positioned at two opposite sides of the main lens hole 111.

The main image module 20 includes a main projecting unit 21 and a main control unit 22 connected to the main projecting unit 21. The main control unit 22 outputs a main image signal to the main projecting unit 21. The main projecting unit 21 projects a main image according to the main image signal outputting from the main control unit 22.

The main projecting unit 21 is partly received in the main body 10, and includes a main lens 211 and a first optical engine 212 used to project light rays to the main lens 211. The main lens 211 protrudes from the main lens hole 111. The main control unit 22 is connected to the first optical engine 212, and controls the first optical engine 212 to project the light rays. The light rays penetrate the main lens 211 and form the main image.

The secondary image module 30 includes two secondary projecting units 31 and a secondary control unit 32 connected to the secondary projecting units 31. The secondary control unit 32 outputs a background image signal to the secondary projecting units 31. The secondary projecting units 31 project two background images according to the background image signal that is outputting from the secondary control unit 32. The secondary control unit 32 is connected to the main control unit 22, and the background image signal can be extracted from the main image signal.

Each secondary projecting unit 31 is partly received in the main body 10, and includes a secondary lens 311 and a second optical engine 312 projecting light rays to the secondary lens 311. The secondary lens 311 protrudes from the secondary lens hole 112. The secondary control unit 32 is connected to the second optical engine 312, and controls the second optical engine 212 to project the light rays. The light rays penetrate the secondary lens 311 and then form the background image.

In this embodiment, the color of the background image is extracted from the color of the background of the main image. The background image is coordinated with the background of the main image. The extracting method may be chosen from a frame difference method, an optical flow method, and a background subtraction.

In order to improve visual effects, the position relationship between the main projecting unit 21 and the secondary projecting unit 31 can be adjusted by a designer. The two opposite edges of the main image projected from the main projecting unit 21 are connected to the edges of the background images projected from the two secondary projecting units 31.

The user setting unit 40 is connected to the secondary control unit 32, and stores a number of background modes, such as, starry sky, ocean, and grassland. User can choose the background mode by the user setting unit 40 according to the personal preference or the main image. The secondary control unit 32 controls the second optical engine 212 to project the background images corresponding to the chosen background mode. The background images are coordinated with the background of the main image.

The starting unit 50 is connected to the secondary image module 30. The second image module 30 projects the background image when the starting unit 50 outputs a starting signal. When the starting unit 50 is triggered by a user, the second image module 30 outputs the background image.

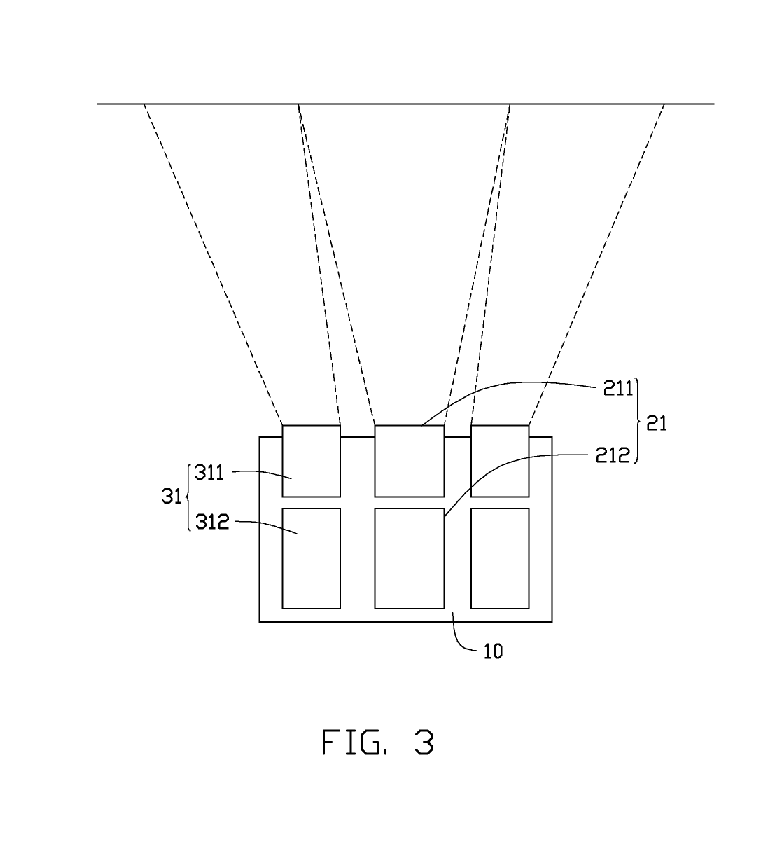

FIG. 3 shows that in use, the projector 100 is turned on, and the main image module 20 projects the main image from the main lens 211. When the user wants to improve the visual effect, the starting unit 50 is triggered. The second image module 30, as default settings, extracts the background image signal from the main image signal outputting from the main image module 20. The secondary projecting units 31 project the background images coordinating with the background of the main image. The two background images projected from the two secondary lenses 311 are connected with two sides of the main image projected from the main lens 211. When the user wants to manually define the background image, the user chooses the background mode with the user setting unit 40 according to the personal preference or the main image. The secondary projecting units 31 project the background images according to the chosen background mode.

The projector 100 projects two background images on two sides of the main image, the background images are coordinated with the main image, and the visual effect of the user is improved.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A projector, comprising:
a main image module comprising a main projecting unit and a main control unit outputting a main image signal to the main projecting unit, the main projecting unit projecting a main image according to the main image signal; and
a secondary image module comprising two secondary projecting units and a secondary control unit outputting a background image signal to the secondary projecting units, the secondary projecting units projecting two background images according to the background image signal; wherein
the two secondary projecting units are positioned at two sides of the main projecting unit, and the background images coordinate with the background of the main image.

2. The projector of claim 1, wherein the secondary control unit is connected to the main control unit, and extracts the background image signal from the main image signal.

3. The projector of claim 1, comprising a user setting unit connected to the secondary control unit, and the user setting unit storing a plurality of background modes.

4. The projector of claim 3, wherein the secondary control unit controls the secondary projecting units to project the background images corresponding to one of the background modes chose by the user setting unit.

5. The projector of claim 1, comprising a starting unit connected to the secondary controlling unit, and the second projecting units projecting the background images when the starting unit outputs a starting signal to the secondary controlling unit.

6. The projector of claim 1, comprising a main body, wherein the main body comprises a front side, the main body defines a main lens hole and two secondary lens holes on the front side, and the two secondary lens holes are positioned at two sides of the main lens hole.

7. The projector of claim 6, wherein the main projecting unit comprises a main lens protruding from the main lens hole, and each secondary projecting unit comprises a secondary lens protruding from a respective one of the second lens holes.
